(19) United States
(12) Patent Application Publication
(10) Pub. No.: US 2004/0131348 A1
(43) Pub. Date: Jul. 8, 2004

(54) Real-time omnifocus microscope camera

(76) Inventors: Kohtaro Ohba, Tsukuba-shi (JP); Tomohiko Nagase, Chiyoda-ku (JP); Hiroshi Nagai, Chiyoda-ku (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/472,491

(22) PCT Filed: Oct. 29, 2001
(86) PCT No.: PCT/JP01/09481

(30) Foreign Application Priority Data
Mar. 30, 2001 (JP) 2001-100594

(51) Int. Cl. G02B 21/36

(52) U.S. Cl. 396/432

(57) ABSTRACT

A real-time all-in-focus microscopic camera is able to display all-in-focus images as motion pictures of a high frame rate. The real-time all-in-focus microscopic camera comprises a movable focal mechanism (11A) of which focal length is changeable at a high repetition frequency, a lens driver (16) driving the mechanism (11A) to change the focal length corresponding to the repetition frequency, a high-speed imaging camera (12) imaging an object through the movable focal mechanism (11A) at a fast frame rate that allows images to be read out a plurality of times (for example, 8 times) every repetition period corresponding to the repetition frequency, and an image processor (13) processing the images acquired by the camera (12) into all-in-focus images in real time. The resultant all-in-focus images are displayed on a monitor (15). The image processor (13) is also able to perform processing for removing a ghost resulting from the fact that a blur is caused at the peripheral portion of an object to be observed.

### TECHNICAL FIELD

The present invention relates to a real-time all-in-focus microscopic camera that provides, as motion pictures, all-in-focus images of which viewing fields are all in-focused, respectively.

### BACKGROUND ART

In recent years, various operations which require an operator to use a microscopic camera, such as operating cells or genes or assembling micro machines, is on the increase.

For performing these operations, an operator should work with viewing an object through a lens, so that, in most cases, it is required for the operator to focus the lens. To be specific, the operator is required to manually adjust the focal length of a microscopic camera to focus each of the depth-directional portions of an object to be observed. Observing the images of each depth-directional portion of the object, which are acquired in response to each time of focusing, will lead to formulation of a three-dimensional shape of the object in the operator's mind. The operator will rely on this shape formulated in the mind when the operator does work. However it takes a long time and needs a large amount of labor in doing this work, so that operation efficiency is low and a comparatively large amount of burden is given the operator. It is also required for the operation to have a skill in completing work to be desired.

When the person observes an object with the naked eye, it is normal that the person eyes focus onto far locations as well as near locations. The reason is that the eyes function as a variable-focal mechanism in such a manner that near in-focused images and far in-focused images are mutually synthesized in the mind in an automatic fashion.

Like the variable-focal mechanism realized by the human eyes, an all-in-focus microscopic camera has got a lot of attention as a camera which is always in-focused onto all the positions of the field of view without manual focus-adjustment operations. It hat been known that this type of conventional all-in-focus microscopic camera is driven by mechanically moving a lens so as to focus onto each position of the field of view.

However, in the conventional all-in-focus microscopic camera in which the lens is moved mechanically to various positions, it takes a long time (a few seconds to a few minutes) to obtain an all-in-focus image. This is far from real-time observation, whereby operation efficiency of work with this camera is lowered.

### DISCLOSURE OF THE INVENTION

An object of the present invention is to provide, with due consideration to the situations concerning with the conventional all-in-focus microscopic camera, a real-time all-in-focus microscopic camera that is able to visualize, as motion pictures, all-in-focus images of a higher frame rate, thus providing all-in-focus images which are superior in the real-time performance (i.e., a live characteristic), which is as close as human eyes' direct observation.

A principle of a real-time all-in-focus microscopic camera according to the present invention will now be outlined below.

The real-time all-in-focus microscopic camera adopts a movable-focal mechanism of which focal length is changeable at a fast rate. The movable-focal mechanism is able to change the focal length in sequence at a repetition rate larger than, for instance, 100 times per second. In order to visualize motion pictures at a high real-time performance, it is required to have a frame frequency of 30 Hz or more. Hence, by way of example, the focal length of a lens of this camera is changed at a repetition frequency of 30 Hz or more. For example, during a period of 1/30 seconds, a large number of images (a plurality of frames) are taken in, and a portion (region or pixel) which is in-focused in each image is extracted. All of the extracted portions are synthesized into one frame of image to produce a single all-in-focus image. This production of the single all-in-focus image is repeated 30 times per second, for instance. This way of processing makes it possible to provide a real-time all-in-focus microscopic camera that has a real-time all-in-focus function, like the human eyes.

Based on the above principle, in the present invention, there is provided a real-time all-in-focus microscopic camera comprising: a movable focal mechanism having a focal length changeable corresponding to a fast repetition frequency regarded as substantially being real time; a lens driver driving the movable focal mechanism to change the focal length corresponding to the repetition frequency; a high-speed imaging apparatus imaging an object through the movable focal mechanism at a fast frame rate that allows images to be read out a plurality of times every repetition period corresponding to the repetition frequency; and an image processor processing the images acquired by the high-speed imaging apparatus into all-in-focus images in real time.

Preferably, the real-time all-in-focus microscopic camera further comprises a display apparatus displaying the all-in-focus images processed by the image processor. Still preferably, the high-speed imaging apparatus is configured to perform imaging based on at least one of techniques consisting of parallel and simultaneous reading of image data from a plurality of divided regions or a plurality of pixels composing a pixel region for the imaging, and, reducing the number of pixels to be read out when reading image data from the individual pixels of the pixel region.

Further, a preferred example is that the image processor comprises evaluation means for evaluating, pixel by pixel, a value of IQM (Image Quality Measure) on a plurality of two-dimensional images acquired while the focal length of the movable focal mechanism is changed within a predetermined range and image producing means for producing each of the all-in-focus images by mapping image data at each pixel which is best in-focused on the basis of the value of the IQM evaluated by the evaluation means. In this case, by way of example, the evaluation means is configured to analyzing a local spatial frequency and applying smoothing at and to image data of each pixel on each of the plurality of two-dimensional images. In addition, it is preferred that the image producing means includes removal means for removing, from the image data at each of the pixels which are best respectively, image data at pixels where a blur of the object is laid on a peripheral portion of the object. This removal means provides all-in-focus images with almost no ghost image and with high reliability. As one example, the removal means is configured to apply, to the value of the IQM evaluated by the evaluation means, processing using a predetermined threshold of the IQM such that the image data at the pixels where the blur of the object is laid on the peripheral portion of the object is removed.

### BRIEF DESCRIPTION OF THE DRAWINGS

In the accompanying drawings:

FIG. 1 is a block diagram showing the entire configuration of a real-time all-in-focus microscopic camera according to a first embodiment of the present invention;

FIG. 2 is a functional block diagram primarily showing the functions of the real-time all-in-focus microscopic camera;

FIG. 3 illustrates scan timing carried out by a high-speed imaging camera:

FIG. 4 pictorially shows the configuration and operations of both of a camera sensor and a camera output circuit incorporated in the high-speed imaging camera;

FIG. 5 is a functional block diagram explaining simplified evaluation processing of an IQM value, which is carried out by an image processor;

FIGS. 6A to 6C each pictorially show a single-focus image, which are drawn for comparison with an all-in-focus image;

FIG. 6D pictorially exemplifies an all-in-focus image, which is drawn for comparison with the single-focus images shown in FIGS. 6A to 6C;

FIG. 7A pictorially exemplifies an image in which a ghost to be removed is present, which is illustrated for a second embodiment of the present invention;

FIG. 7B, which is shown for comparison with FIG. 7A, pictorially exemplifies an image obtained after the ghost removal processing carried out in the second embodiment; and

FIG. 8 is a flowchart showing an algorism for image processing including ghost removal processing, which is executed by the real-time all-in-focus microscopic camera according to the second embodiment.

### PREFERRED EMBODIMENTS FOR CARRYING OUT THE INVENTION

With reference to the accompanying drawings, a real-time all-in-focus microscopic camera according to embodiments of the present invention will now be described.

### First Embodiment

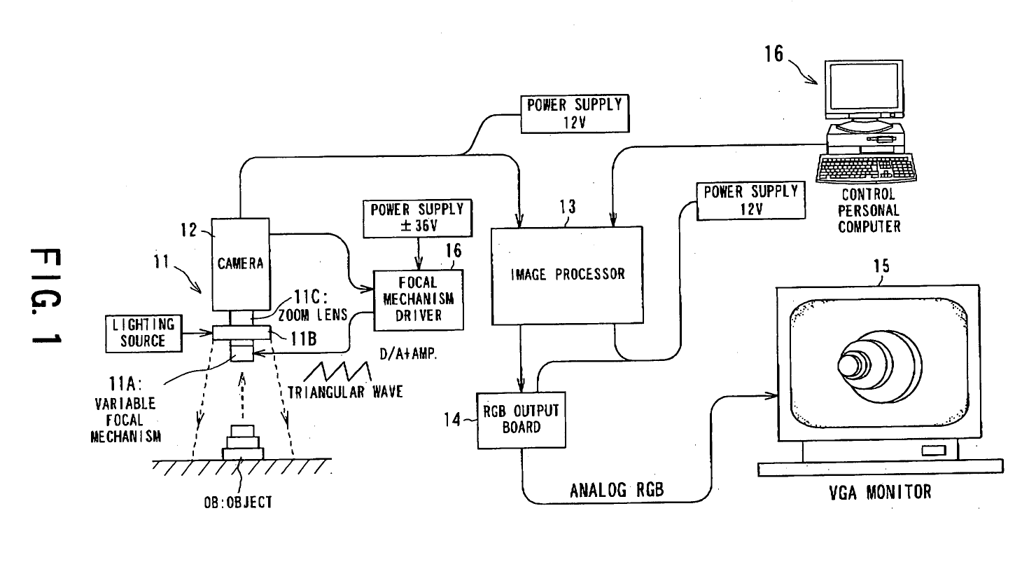

Referring to FIGS. 1 to 6, a first embodiment of a real-time all-in-focus microscopic camera according to the present invention will now be described.

FIG. 1 shows an entirely outlined configuration of the real-time all-in-focus microscopic camera This microscopic camera is provided with an optical system 11 to receive light reflected from an object OB and a high-speed imaging camera to which the optical system 11 is attached. The high-speed imaging camera, which serves as a high-speed imaging apparatus, composes a camera head of the real-time all-in-focus microscopic camera. This real-time all-in-focus microscopic camera is further provided with an image processor 13 to receive data imaged by the high-speed imaging camera 12 and process the received data at a high rate for producing all-in-focus images, an RGB output board 14 to perform coloring processing on the all-in-focus images produced by the image processor 13, and a monitor 15 to visualize the all-in-focus images that have been subjected to the coloring processing at the RGB output board 14. In addition, the microscopic camera has a lens driver 16.

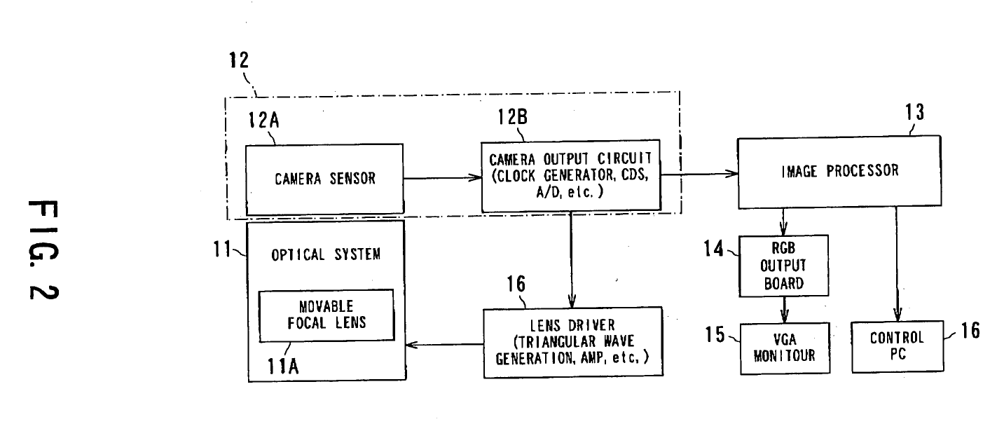

FIG. 2 shows a functional block diagram of the real-time all-in-focus microscopic camera provided with the foregoing components. The high-speed imaging camera 12 is provided with a camera sensor 12A and a camera output circuit 12B to process an output signal from the camera sensor.

The optical system 11 has a movable focal mechanism 11A, a lighting system 11B, and a zoom lens 11C, which are arranged in this order in the reflected direction from the object OB.

Of these components, the movable focal mechanism 11A adopts a piezoelectric element to which voltage is applied to control a focal length thereof. Such a configuration has been known by, for example, “T. Kaneco et at., “A Long-focus depth visualizing mechanism using a variable focal lens,” Institute of Electrical Engineers, Micromachine study group 1997” and “Takashi Kaneco et al., “A New Compact and Quick-Response Dynamic Focusing Lens,” Transducers 97, 1997.”

The variable focal mechanism 11A is configured, by way of example, to have a PZT bimorph actuator and a glass diaphragm. Changing voltage applied to the PZT bimorph actuator will lead to changes in the glass diaphragm. Raising the frequency of the voltage applied to the actuator causes the glass diaphragm to change at a high rate, thus changing its focal length at a fast speed from focal lengths for a convex lens to those for a concave lens, it has been confirmed that this movable focal mechanism 11A exhibits a frequency response with no phase delay up to 150 Hz or thereabouts. When no voltage is applied to the PZT bimorph actuator, this actuator remains a flat glass.

The movable focal mechanism 11A is secured to the tip of the micro zoom lens 11C with the lighting system 11B therebetween. This configuration provides variable focus means for scanning the inherent optical characteristics (focal length) of the micro zoom lens at a high speed.

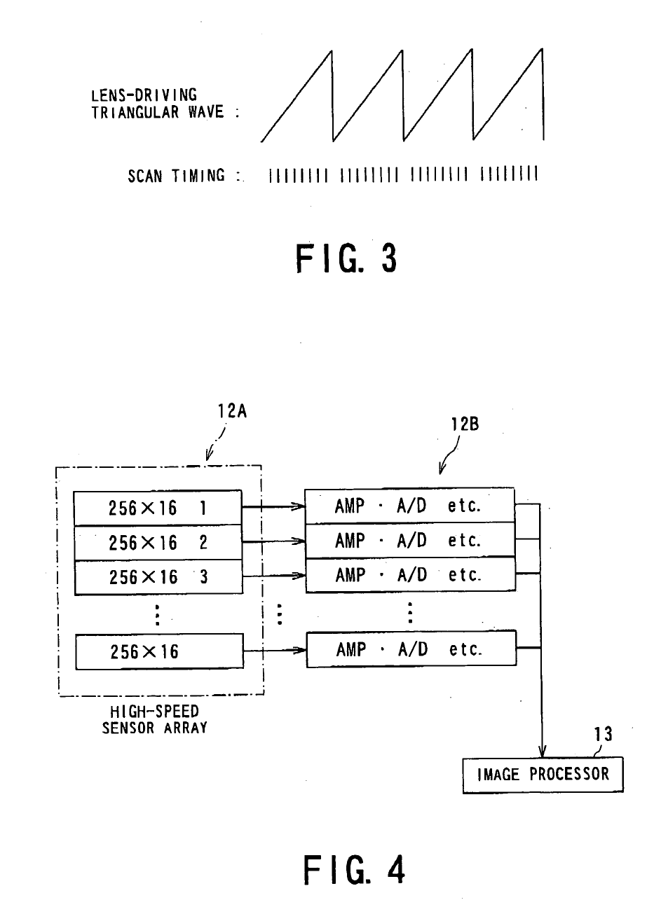

FIG. 3 shows timings at which the lens driver 16 drives the foregoing movable focal mechanism 11A. As shown in FIG. 3, the movable focal mechanism 11A is driven in synchronism with a triangular wave of 30 Hz, in which eight times are scanned per each triangular waveform. This triangular wave is generated by the lens driver 16 with the use of a synchronization signal sent from the camera output circuit 12B of the high-speed imaging camera 12. As stated above, the movable focal mechanism 11A with the piezoelectric element has a hysteresis characteristic, the hysteresis of the mechanism 11A is always reset every triangular waveform (i.e., per eight-time scan).

Before explaining the high-speed imaging camera 12, various techniques for high-speed imaging will now be explained.

The high-speed imaging camera usually adopts a scheme for raising a frame rate, which is attained by employing solely or employing in a combination 1) raising a reading clock at the sensor, 2) reducing the number of reading pixels in the sensor, and/or 3) reading pixels in parallel in the sensor.

Of these techniques, the first technique of raising the pixel rate would be easier to understand in a theoretical viewpoint, but there are limitations in the high-speed imaging in terms of the characteristics of a sensor device and/or the conditions of a peripheral circuit.

The second technique of reducing the number of pixels to be read is realized as follows. For instance, if there is a sensor of 500×500 pixels which can be imaged at a frame rate of 30 frames, reading pixels is stopped when 250×250 pixels have been finished to be read, before proceeding to reading the pixels for the next frame. This way of reading the pixels is speeded up four times, thus the number of frames being 120 frames (=30×4). In this case, however, the resolution of images reduces.

The third technique of reading pixels in parallel has been executed in various modes. One example is that the region of pixels composing an imaging region is formed into plural regions each having a certain area serving as a high-speed imaging sensor. For example, high-speed cameras “ULTIMA series” produced by PHOTRON Limited have a high-speed sensor (256 pixels (in the lateral direction)×16 pixels (in the longitudinal direction), as pictorially shown in FIG. 4. In other words, the camera has the 16 independent high-speed sensors arranged in an array in parallel with each other, thereby providing an imaging region of a pixel size of 256×256 pixels as a whole. Each high-speed sensor is subjected to pixel reading at 25 MHz.

The camera sensor 12A of the high-speed imaging camera 12 according the present embodiment adopts the foregoing third parallel-imaging technique, and as shown in FIG. 4, the imaging high-speed image sensors are disposed in an array. Incidentally, the high-speed imaging camera 12 may be configured by solely employing the foregoing second technique or employing a combination of the second and third techniques.

Still, the third parallel-imaging technique may be executed in other various parallel-imaging modes, not limiting to the above configuration where the plural high-speed sensors are disposed in an array in parallel with each other.

One such an example is that a single imaging region (for example, 256×256 pixels) serving as an imaging region is divided into a plurality of regions (for example, four regions) in both the lateral and longitudinal directions and image data are read simultaneously in parallel from the plural divided regions for speeding up the reading operation.

Another example concerns with a configuration where, from the pixel data of a single imaging region, image data are read simultaneously every plural lines (for example, two lines each consisting of for example 256 pixels) until all the lines are finished being read out, so that the reading operation can be speeded up.

Still another example is to read simultaneously image data from plural pixels (for example, 10 pixels) of each line (for example, 256 pixels) composing a single imaging region, before being repeated along the line and then the remaining lines, so that the reading operation can be speed up.

The camera output circuit 12B is provided with a processing circuit that has an amplifier, CDS (Correlated Double Sampling) circuit, and A/D converter for each of the sensors, in addition to a clock generator. Hence, image data coming from the camera sensor 12B is fed to the camera output circuit 12B, in which the image data is amplified, CDS-processed and digitized every processing circuit. Data outputted from the camera output circuit 12B is supplied to the signal processor 13 on the basis of an LVDS (Low Voltage Differential Signaling).

The image processor 13 is composed of, for instance, hardware logics that use a high-speed and large-capacity FPGA (Field Programmable Gate Array). This image processor 13 has a board on which the FPGA, a large-capacity SDRAM, and an LVDS interface to interface with external devices. The SDRAM provides various types of memories from and into which original images acquired from the high-speed imaging camera 12, values of an IQM (Image Quality Measure) which will be described later, all-in-focus images, and information about a focal length can be read and written.

The image processor 13 is responsible for, pixel by pixel, evaluating an IQM value of image data taken in, while the focal length of the movable focal mechanism 11A is changed.

Before the evaluation, the IQM will be described. The IQM is based on an optical theory called “Depth from Focus.” (For instance, refer to such papers as “Masahiro Watanabe and Shree K. Nayer, “Minimal Operator Set for Passive Depth from Defocus,” CVPR96. pp.431-438, 1996”; “Shree K. Nayer, Masahiro Watanabe and Minoryu Noguchi “Real-Time Focus Range Sensor,” ICCV '95, pp.995-1001, 1995”; “Shree K. Nayer and Yasuo Nakagawa, “Shape from Focus,” IEEE Trans. on PAMI, Vol. 16, No.8, pp.824-831, 1994”; “A. P. Pentland, “A New Sense for Depth of Field,” IEEE Trans. On Pattern Analysis and Machine Intelligence, Vol.PAMI-9, No.4, pp.523-531, 1987”; “Michio Miwa, Tomoyuki Oohara, Masahiko Ishii, Yasuharu Koike, and Makoto Sato, “A Method of Far Object Recognition using Depth from Focus,” Proc.3D Image Conference '99, pp.305-307, 1999.”)

This theory of “Depth from Focus” shows that whether an image is in-focused or not can be determined through an analysis of local spatial frequency on the image and a focal length showing a peak of the analyzed local spatial frequencies gives an in-focused portion. Intuitively, it could be imagined that a blurred portion has a lower spatial frequency and an in-focused portion has a higher spatial frequency. As a basic manner, while the movable focal mechanism 11A is driven to change the focal length of the lens, image data is acquired every image frame. Each image is subjected to a spatial frequency analysis locally carried out at each pixel or each region on each of the respective images, so that a portion showing a peak frequency, i.e., an in-focused portion is picked up pixel by pixel or region by region from each image. Each in-focused portion is then mapped into a single image, thus providing an all-in-focus image. In addition, based on those focal lengths, the three-dimensional data of an object imaged into the all-in-focus images can be obtained as well.

The analysis of local spatial frequency at each pixel is carried out through a spatial dispersion of image intensity values defined by the following formula, which provides an evaluated value (i.e., IQM evaluated value) of the IQM (Image Quality Measure).

$$IQM = ( 1 / D ) {\sum }_{x - xi}^{xf} {\sum }_{y - yi}^{yf} \{ {\sum }_{P - Lc}^{Lc} {\sum }_{q - Lr}^{Lr} \vert I ( x , y ) - I ( x + p , y + p ) \vert \}$$

In this formula, a reference “I” denotes image densities (signal intensities) and references “(−L_{c}, −L_{c})−(L_{c}, L_{c})” and “(x, y) (x, y)” denote small areas for evaluating the dispersion and smoothing, respectively. The first two summation terms show the processing for smoothing, and the next processing in parenthesis, which includes the two summations, show the processing for dispersion. Further, a reference “D” denotes the number of all pixels to be evaluated, the number being used for normalization carried out pixel by pixel.

Accordingly, while moving the focal length of the movable focal mechanism 11A, the IQM evaluated value is evaluated every pixel or every region to detect a peak of the IQM evaluated values. When the peak is detected, an object distance “X” calculated using a pixel intensity value “f” and an image distance “x” is substituted into matrix elements corresponding to each pixel position. This processing is repeated for all focal lengths, whereby the respective matrices becoming an all-in-focus image and a depth image.

The processing for this IQM can be summarized as being analyzing a local spatial frequency over 3 neighborhoods (i.e., a Laplacian filter) and soothing processing over a local area of 2×2 pixels (i.e., a median filter). For accomplishing these filtering processes, the image processor 13 performs the analysis of such local spatial frequencies, and then performs the smoothing processing, with the result that image data which is best in-focused is detected pixel by pixel. The detected image data are mapped to form an all-in-focus image, which is then visualized.

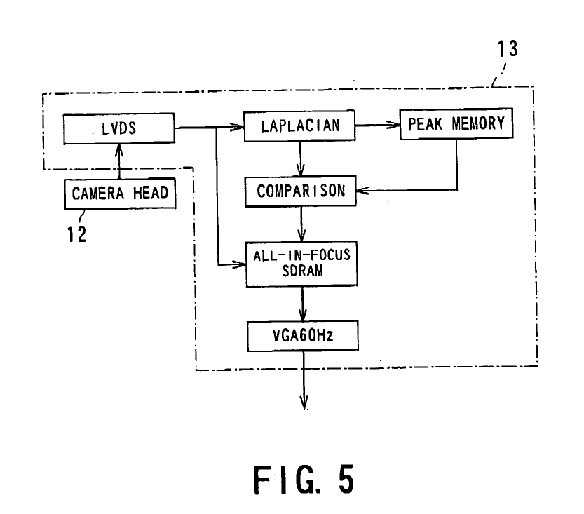

In contrast, the image processor 13 is also able to execute image processing simplified as shown in FIG. 5. An image signal of 80 MHz sent from the high-speed imaging camera 12 is subjected to an analysis of a spatial frequency at a Laplacian circuit, before being written into a peak memory. The output from the Laplacian circuit is compared with that from the peak memory to determine whether or not the output of the Laplacian circuit is a peak value. If the output is a peak, that is, an in-focused pixel image, the peak value is written into a frame memory in a SDRAM. If the output is not a peak, the output is discarded.

The image data written into the SDRAM is sent to the VGA monitor 15 via the RGB output board 14 in the form of a standard VGA signal whose frame rate is 60 Hz. In addition, three-dimensional data composed of focal lengths is converted to LVDS and then transferred to the control PC.

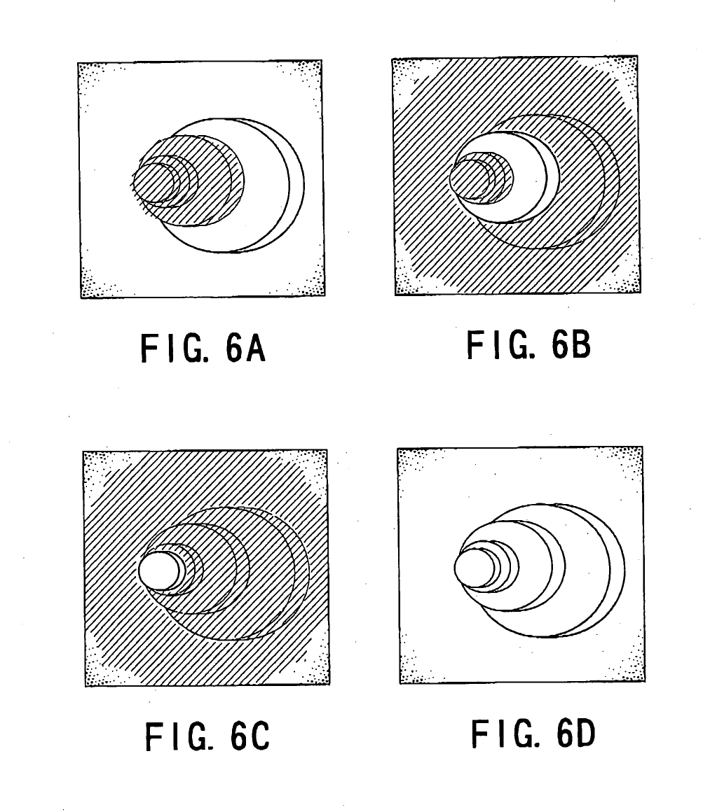

FIG. 6D pictorially shows a camera image obtained by this real-time all-in-focus microscopic camera, which is displayed by the VGA monitor 15 through the foregoing processing. The camera images shown in FIGS. 6A to 6C, which are not all-in-focus images, provides a state where a lower part of an object is in-focused (FIG. 6A), another state where a middle part of the object is in-focused (FIG. 6B), and another state where an upper part of the object is in-focused (FIG. 6C), respectively. By contrast, in the case of the camera image obtained in the present embodiment, while the focus of the lens 11A is moved, real-time all-in-focus images can be obtained (at a high speed). As a result, as shown in FIG. 6D, the object is always in-focused over its all depth-directional lengths.

In this way, in the present embodiment, a real-time all-in-focus microscopic camera image can be obtained. Therefore, there is no necessity of imagining a three-dimensional shape of an object in the operator's mind. Since a field of view is entirely in-focused at any time, it is not necessary for an operator to adjust the focal length of the camera. Additionally, “live (real-time)” images can be obtained. In other words, there is hardly a delay in displaying the images of a desired field of view, so that motions of an object in the image can be observed almost in real time. Efficiency of work involving use of the microscopic camera can be raised to a great extent.

When comparing the above with the conventional all-in-focus microscopic camera in which the focus of a lens is mechanically adjusted, the effectiveness of the camera according to the present embodiment becomes remarkable. In the case of the conventional camera, it was required that the focus be mechanically adjusted and post-processing of acquired image data be done, resulting in that it took a long time (from a few seconds to a few minutes) to obtain a single image. The conventional camera provided still pictures, because it employed a normal video camera of 30 frames. The conventional camera is no longer impossible to obtain live motion pictures. Work with the microscope will get involved with a delay, because images change only at intervals of a few seconds, thus making it difficult to complete the work with the use of the conventional microscopic camera. A frame frequency that gives smoothly-changing motion pictures to the human is 30 or more pictures per second. The frame scanning rate of the real-time all-in-focus microscopic camera according to the present embodiment is 240 pictures per second. To be specific, frame images are taken in eight times during a period of 1/30 seconds as the focus is changed continuously, so that a rate of 240 (30×8) frames per second can be realized. This secures a sufficient real-time performance which is as close as to that obtained when the human usually sees objects (without using a microscope).

Though the human person sees objects in a real-time all-in-focus mode in normal daily activities, it is required for the human person to use a microscope once entering the microscopic world. The conventional microscope was a real-time microscope, but a single focus. For this reason, the conventional microscope urged an operator to adjust its focus in a complicated manner. In contrast, the use of the real-time all-in-focus microscopic camera according to the present invention makes it possible for the operator to handle objects in the microscopic world as if the operator performs operator's daily activities.

Furthermore, observing an object under a microscope involves preparing for a spall, which is pre-work for an operator. This preparation is, however, based on the premise that the microscope is in-focused onto a single spot. In the present embodiment, the microscopic camera provides focuses onto all the spots, so that some cases do not need the preparation of the spall.

It is estimated that the real-time all-in-focus microscopic camera according to the present embodiment provides the human person with an opportunity for observing the entire motions of a micromachine and ecology of animate things, which have yet to be observed by the human.

### Second Embodiment

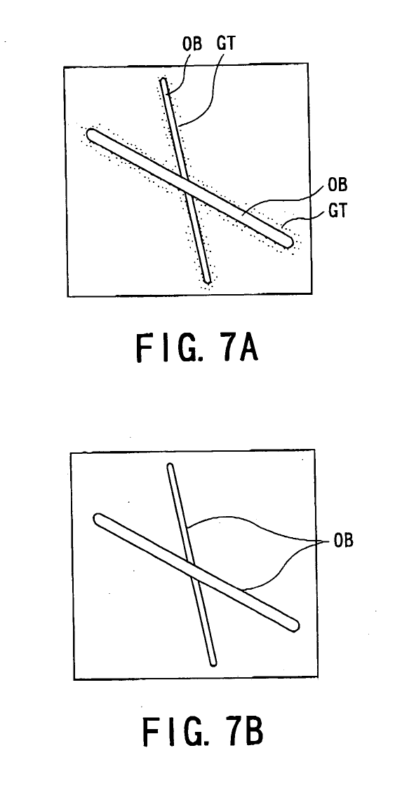

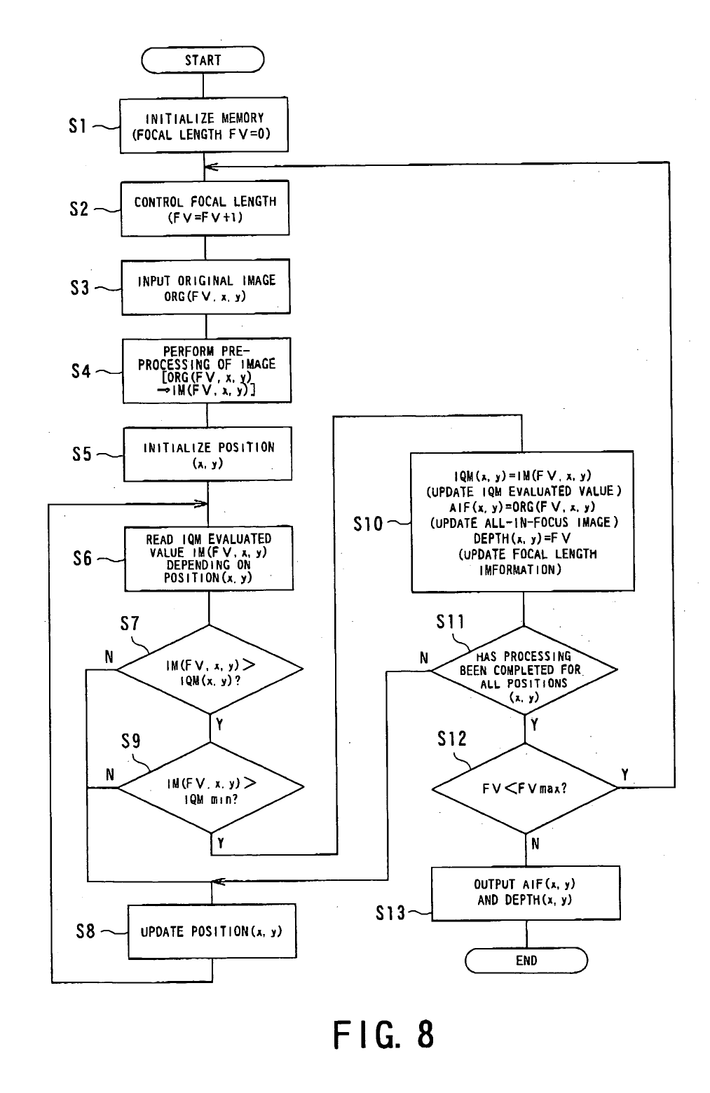

Referring to FIGS. 7A, 7B and 8, a second embodiment of the real-time all-in-focus microscopic camera according to the present invention will now be described.

The real-time all-in-focus microscopic camera described in this second embodiment is directed to use where light is illuminated from the back of an object to be observed, like a biological microscope. Particularly, this embodiment concerns with a real-time all-in-focus microscopic camera with a filtering function for removing artifacts called “ghosts.”

The ghosts, which are caused when the foregoing real-time all-in-focus microscopic camera according to the first embodiment is used as a biological microscope, will now be explained. In the situation all the positions of a filed of view are in-focused within a movable range of the focal length of a real-time all-in-focus microscopic camera, the foregoing DFF theory can be applicable to imaging an object. Hence, when the light is illuminated from the back of an object, like the biological microscope, no object should be photographed into the background area of an image, because, within a movable range of the focal length of the camera, there are not in-focus objects in the background area of an object to be observed.

However, actually, an object to be observed creates a blur at the periphery of the object, so that blurred portions are laid on the periphery. For this reason, if the algorithm of image processing on the foregoing IQM theory is applied to this situation as it is, the blurred portions are read out as in-focus normal image pixels. Such blurred portions are erroneously recognized as if they are actual objects existing around the object to be observed. FIG. 7A illustrates this situation, where there is an image on which an object OB to be observed is photographed together with its blurred portions represented as a ghost image GT.

Therefore, in addition to the function of displaying all-in-focus images as motion pictures at a high frame rate, like that explained in the first embodiment, a real-time all-in-focus microscopic camera according to the second embodiment is to supply more reliable images by removing the foregoing ghost image without fail, even when being used as a biological microscope.

The real-time all-in-focus microscopic camera according to the second embodiment is configured in its entire hardware architecture in the same way as that of the second embodiment, so that its configuration is omitted from being detailed. The image processor 13 may be configured as a processor with a CPU and some memories, not limited to the hardware logic circuit on FPGA, like the first embodiment. When the image processor 13 is based on the software architecture, a program providing an algorithm shown in FIG. 8 is previously stored in a memory.

In order to prevent the foregoing ghost image to be imaged, the image processor 13 processes image data acquired by moving the focal length of the movable focus mechanism 11A, so that the IQM values are evaluated, pixel by pixel, based on the algorism shown in FIG. 8. The algorithm includes filtering to remove the foregoing ghost. The algorithm shown in FIG. 8 provides a functional flow of processing carried out by the image processor 13 configured using either the hardware-logic architecture or CPU-based software architecture.

To be specific, the image processor 13 initializes a not-shown memory for a focal length FV to be used in evaluating IQM values (that is, FV=0; step S1 in FIG. 8). Then the focal length FV is incremented (FV=FV+1; step S2).

The image processor 13 then goes to the next step, where original-image intensity data ORG(FV, x, y) at a pixel position (x, y) in a two-dimensional plane locating at the current focal length FV is read out (step S3). In order to evaluate IQM values, the image processor 13 applies various types of processing to the read-out intensity data ORG(FV, x, y) as follows.

Specifically, the read-out original-image intensity data ORG(FV, x, y) is subjected to pre-processing (step S4). This pre-processing is composed of, as described before, the filtering for evaluating IQM values (i.e., a Laplacian filer for analyzing local spatial frequency and a filter for smoothing). This filtering creates, as described before, an IQM evaluated value IM(FV, x, y) indicative of what degree is in-focused at each position in the three-dimensional space defined by a field of view.

The current pixel position (x, y) is then set to a new initial position (step S5), and an IQM evaluated value IM(FV, x, y) according to the new pixel position (x, y) is read out (step S6).

The read-out IQM evaluated value IM(FV, x, y) is then compared with an IQM evaluated/updated value IQM(x, y) which is updated to have a maximum at each pixel position (x, y). That is, it is determined if IM(FV, x, y)>IQM(x, y) is met or not (step S7) When it is determined NO at this step S7, it is meant that there was a larger value than the currently processed IQM evaluated value IM(FV, x, y) in the past. In such a case, for the comparison of the IQM evaluated value at the next pixel position (x, y), the current pixel position (x, y) is updated (step S8). This positional update is followed by repeating the processing at steps S6 and S7.

In contrast, when it is determined YES at this step S7, it is meant that the currently processed IQM evaluated value IM(FV, x, y) is larger than the IQM evaluated/updated value IQM(x, y) which has been a maximum so far. In this case, the currently processed IQM evaluated value IM(FV, x, y) is greater in the in-focus extent than the past.

Therefore, only this case allows the threshold processing for removal of the ghosts to be carried out with the current IQM evaluated value IM(FV, x, y). That is, a predetermined threshold IQMₘᵢₙ for the IQM evaluated values is used to determine if a condition of IM(FV, x, y)>IQMₘᵢₙ is met or not (step S9).

This IQMₘᵢₙ is set to a value appropriately larger than an IQM evaluated value that corresponds to a normal pixel value in the blurred areas on and around the periphery of an object to be observed. Hence, the determination at step S9 becomes NO at each pixel position (x, y) in the blurred areas (i.e., IM(FV, x, y)≦IQMₘᵢₙ).

In response to this determination of NO at step S9, the processing is made to proceed to the foregoing step S8. In other words, without executing later-described update processing (step S10) for the IQM evaluated value, the processing is forced to shift to the update of pixel positions and the comparison of an IQM evaluated value at each updated pixel position (steps S8, S6 and S7).

In contrast, when the determination at step S9 becomes YES (i.e., IM(FV, x, y)>IQMₘᵢₙ), the recognition is made such that an IQM evaluated value of which in-focus degree is higher than those in the past has been obtained. Thus, in only this case, information concerning the IQM evaluation at the current pixel position is used to update the IQM evaluated/updated value IQM(x, y), an all-in-focus image AIF(x, y), and focal length information DEPTH(x, y), which have been obtained so far (step S10).

More concretely, the IQM evaluated/updated value IQM(x, y) is replaced by the currently processed IQM evaluated value IM(FV, x, y) (i.e., the update of the evaluated values), a pixel value at a corresponding position (x, y) of the all-in-focus image AIF(x, y) is replaced by corresponding data ORG(FV, x, y) of the original image (i.e., mapping of pixel images to the all-in-focus image (production)), and the focal length information DEPTH(x, y) is updated using the currently obtained focal length FV. The thus-updated IQM evaluated/updated value IQM(x, y) is used again for evaluation carried out at step S7 at the corresponding position (x, y) in a two-dimensional plane locating at the next focal length FV+1.

When completing the update of the information at step S10, the image processor 13 determines if the foregoing processing has finished at all the pixels (x, y) on the two-dimensional plane locating at the current focal length FV (step S11) If it is determined NO at step S11, the processing is made to return to step S8, whereby the pixel position (x, y) advances to the new one for which the foregoing processing is repeated (steps S8, S6, S7, S9 to S11).

On the other hand, when it is determined YES at step S12, that is, when the foregoing processing has been completed for all the pixel positions (x, y), it is further determined whether or not the current focal length FV is smaller than its predetermined upper limit FVₘₐₓ (step S13). When it is determined YES at this step, the recognition is made such that there still remain one or more focal lengths FV to be evaluated, whereby the processing is made to return to step S2. Responsively to this return, the foregoing evaluation processing is then carried out on a new two-dimensional plane existing at a new focal length FV.

When it is determined NO at step S12, it is recognized that the focal length FV has reached to its upper limit FVₘₐₓ. Hence it is found that the evaluation of the IQM has been completed at each pixel position on each two-dimensional plane locating at each focal length within a range of given focal lengths FV. Accordingly, in response to this determination, the all-in-focus image AIF(x, y) and the focal length information DEPTH(x, y), which have been produced so far, are outputted via the RGB output board 14, and then displayed as one frame of image on the VGA monitor (step S13).

The foregoing processing and display is executed at a frame rate of or more frames per second, thus supplying all-in-focus images with an excellent real-time performance.

As understood from the above, only when the AND condition of “IM(FV, x, y)>IQM(x, y) and IM(FV, x, y)>IQMₘᵢₙ” is fulfilled, the update processing at step S10 is performed.

As a result, even when the real-time all-in-focus microscopic camera according to the present invention is applied to, for example, a biological microscope, ghost components due to blurring of an object to be observed can be removed without fail through the performance of evaluating the IQM values. Therefore, as pictorially shown in FIG. 7B in comparison with FIG. 7B, an appearance of ghost images into all-in-focus images is avoided almost completely, thus providing reliable and high-quality all-in-focus images in real time.

Furthermore, as stated before, the process of producing all-in-focus images includes the concurrently performed computation of the focal lengths. It is thus possible to measure three-dimensional data of an object to be observed as well. Such concurrently acquired data can be used for various purposes, thus making operator's observing operations efficient and enriching observed information.

Incidentally, the configuration of the real-time all-in-focus microscopic camera according to the present invention will not be confined to that explained in the above embodiments, but a person having ordinary skill in the art can create a variety of constructions adequately altered or deformed within the scope of the claims. For example, the foregoing variable focal mechanism is not limited to the use of piezoelectric element Alternatively, an actuator capable of moving the lens at a high speed for control of its focal length can be used.

Industrial Applicability

The real-time all-in-focus microscopic camera according to the present invention is able to display all-in-focus images as motion pictures of a higher frame rate, whereby the all-in-focus images can be provided with excellence in a real-time performance (i.e., live characteristic), as if an operator directly observes an object with the naked eye Accordingly, the present invention is able to have much industrial applicability in the fields of various operations which require an operator to use a microscopic camera, such as operating cells or genes or assembling micro machines, acquisition of images and/or information about micro structures of substances, and biological microscopes.

1. A real-time all-in-focus microscopic camera comprising:
a movable focal mechanism having a focal length changeable correspond to a fast repetition frequency regarded as substantially being real time;
a lens driver driving the movable focal mechanism to change the focal length corresponding to the repetition frequency;
a high-speed imaging apparatus imaging an object through the movable focal mechanism at fast frame rate that allows images to be read out a plurality of times every repetition period corresponding to the repetition frequency; and
an image processor processing the images acquired by the high-speed imaging apparatus into all-in focus images in real time.

2. The real-time all-in-focus microscopic camera according to claim 1, further comprising a display apparatus displaying the all-in-focus images processed by the image processor.

3. The real-time all-in-focus microscopic camera according to either claim 1 or 2, wherein the high-speed imaging apparatus is configured to perform imaging based on at least one of techniques consisting of parallel and simultaneous reading of image data from a plurality of divided regions or a plurality of pixels composing a pixel region for the imaging, and, reducing the number of pixels to be read out when reading image data from the individual pixels of the pixel region.

4. The real-time all-in-focus microscopic camera according to any one of claims 1 to 3, wherein the image processor comprises
evaluation means for evaluating, pixel by pixel, a value of IQM (Image Quality Measure) on a plurality of two-dimensional images acquired while the focal length of the movable focal mechanism is changed within a predetermined range and
image producing means for producing each of the all-in-focus images by mapping image data at each pixel which is best in-focused on the basis of the value of the IQM evaluated by the evaluation means.

5. The real-time all-in-focus microscopic camera according to claim 4, wherein the evaluation means is configured to analyzing a local spatial frequency and applying smoothing at and to image data of each pixel on each of the plurality of two-dimensional images.

6. The real-time all-in-focus microscopic camera according to claim 4, wherein the image producing means includes removal means for removing, from the image data at each of the pixels which are best respectively, image data at pixels where a blur of the object is laid on a peripheral portion of the object.

7. The real-time all-in-focus microscopic camera according to claim 6, wherein the removal means is configured to apply, to the value of the IQM evaluated by the evaluation means, processing using a predetermined threshold of the IQM such that the image data at the pixels where the blur of the object is laid on the peripheral portion of the object is removed.

8. The real-time all-in-focus microscopic camera according to any one of claims 1 to 3, wherein the image processor has removal means for removing, from each of the images, a ghost image caused due to a blur of the object, the blur being laid on a peripheral portion of the object.

9. A method of imaging a real-time all-in-focus image, comprising the steps of;
imaging an object to be observed by changing a focal length of a camera corresponding to a fast repetition frequency regarded as substantially being real time, at a fast frame rate that allows images to be read out a plurality of times every repetition period corresponding to the repetition frequency;
processing the read-out images into the all-in-focus image in real time; and
displaying the processed all-in-focus image.

10. The method of imaging the real-time all-in-focus image according to claim 9, wherein the processing step includes a removal process removing, from the image, a ghost image caused due to a blur of the object, the blur being laid on a peripheral portion of the object.

11. (Added) The real-time all-in-focus microscopic camera according to claim 4, wherein the evaluation means has a memory into which peak values of one frame of the IQM evaluated values are stored and means for comparing, pixel by pixel, the peak values stored in the memory with a further frame of the IQM evaluated values, and the image producing means is configured to write, into a display memory, image data shown by the comparison such that the image data provides the IQM evaluated value larger than the peak value at each pixel

12. (Added) The real-time all-in-focus microscopic camera according to claim 4, wherein the image processor comprises evaluation means for obtaining, pixel by pixel or region by region, an IQM (Image Quality Measure) evaluated value on each of a plurality of frames of two-dimensional images acquired at the plurality of times of imaging timing by the high-speed imaging apparatus while the focal length is changed within the predetermined length range and
image producing means for producing each of the all-in-focus images by mapping, pixel by pixel, image data at each pixel which is best in-focused among the plurality of frames of two-dimensional images on the basis of the IQM evaluated value obtained by the evaluation means.

13. (Added) The real-time all-in-focus microscopic camera according to claim 12, wherein the evaluation means has a memory into which peak values of one frame of the IQM evaluated values are stored and means for comparing, pixel by pixel, the peak values stored in the memory with a further frame of the IQM evaluated values, and the image producing means is configured to write, into a display memory, image data shown by the comparison such that the image data provides the IQM evaluated value larger than the peak value at each pixel.
